(19) United States
(12) Patent Application Publication
(10) Pub. No.: US 2002/0071397 A1
(43) Pub. Date: Jun. 13, 2002

(54) Portable communication device and method therefor

(76) Inventor: Bhaktha R. Keshavachar, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/733,545

(22) Filed: Dec. 7, 2000

(51) Int. Cl. H04L 12/26; H04Q 7/00; H04J 3/24

(52) U.S. Cl. 370/252; 370/328; 370/473

(57) ABSTRACT

Briefly, in accordance with one embodiment of the invention, a portable communication device may collect and store user packets of data. The portable communication device may wait until the end of a time interval to transmit the data so that it may be transmitted at a lower transmission power level.

### BACKGROUND

The capacity of a wireless communication network (e.g., the number of communication devices that may be supported by the network) is generally determined by the acceptable bit error rate (BER) and the acceptable signal-to-noise ratio of the communication devices operating within the network. These parameters are often affected by such factors as the amount of noise and interference within the network, multipaths, distance between the communication device and the transmitting base station, and the transmission power of the communication device.

One technique to increase the number of communication devices that may operate within the network is to allow the individual communication devices to determine the acceptable communication parameters, such as the desired Quality of Service (QOS) parameters. QOS parameters may specify the bandwidth at which the communication device may transmit as well as the amount of delay that is acceptable for the transmission of data. For example, the communication device may request a connection to a base station that permits 100 kilo bits/second to be transmitted with each transmission with a maximum delay of 10 milli-seconds.

Although the use of QOS may increase the capacity of the wireless network, it may not reduce the power consumption of the individual communication device. This, in turn, may adversely affect the usable battery life of the communication device. Thus, there is continuing need for better ways to reduce the transmission power of portable communication devices.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic representation of a portable communication device in accordance with an embodiment of the present invention; and

FIG. 2, is a flowchart of a method in accordance with an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description which follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

Types of cellular radiotelephone communication systems intended to be within the scope of the present invention include, although not limited to, Code Division Multiple Access (CDMA) cellular radiotelephone communication systems, Global System for Mobile Communications (GSM) cellular radiotelephone systems, North American Digital Cellular (NADC) celluar radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like.

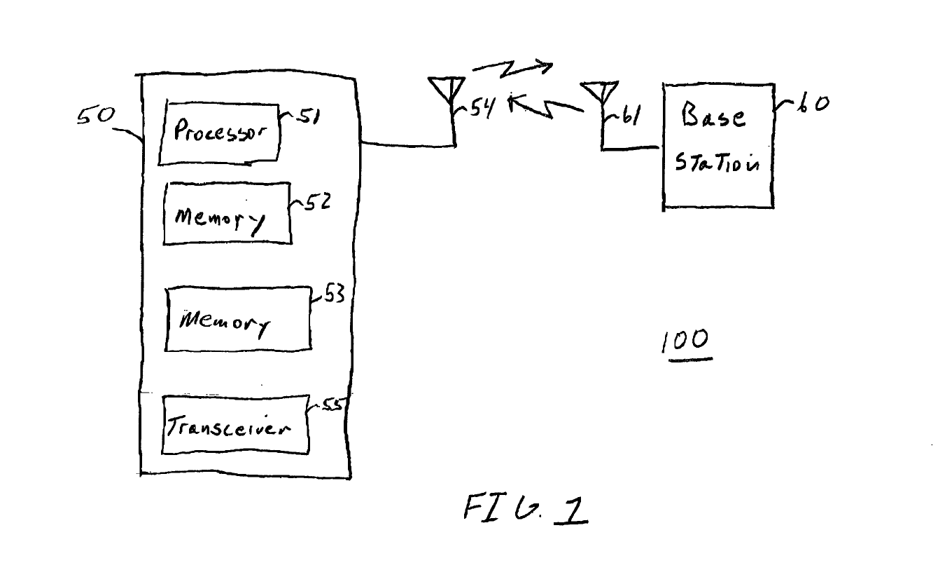

Turning to FIG. 1, an embodiment 100 in accordance with the present invention is described. Embodiment 100 may comprise a portable device such as a mobile communication device 50 (e.g., cell phone), a two-way radio communication system, a one-way pager, a two-way pager, a personal communication system (PCS), a portable computer, or the like. Although it should be understood that the scope and application of the present invention is in no way limited to these examples.

Embodiment 100 here includes a processor 51 that may comprise, for example, a microprocessor, a digital signal processor, a microcontroller, or the like. However, it should be understood that the scope of the present invention is not limited to these examples. Portable communication device 10 may also comprise memories 52-53 that may include volatile memory (e.g., static dynamic random access memory (SRAM), dynamic RAM, etc.) or nonvolatile memory such as Flash, EEPROM, etc. As explained in more detail below, one of memories 52-53 may be used to store packets of data that are to be transmitted. Although the scope of the present invention is not limited in this respect, the other of memories 52-53 may be used to store instructions or a program that is executed by processor 51 while portable communication device 50 is in operation.

Portable communication device may also comprise a transmitter or a transceiver 55 that may be used is conjunction with an antennae 54 to transmit data or information to a base station 60. It should be understood that the present invention may be used with a variety of communication systems that operate at various frequencies. Moreover, the present invention is not intended to be limited to cellular phone system. For example, the present invention may also be used in other forms of wireless communication such as with a Bluetooth TM system, the IEEE 820.11 standards, or the like.

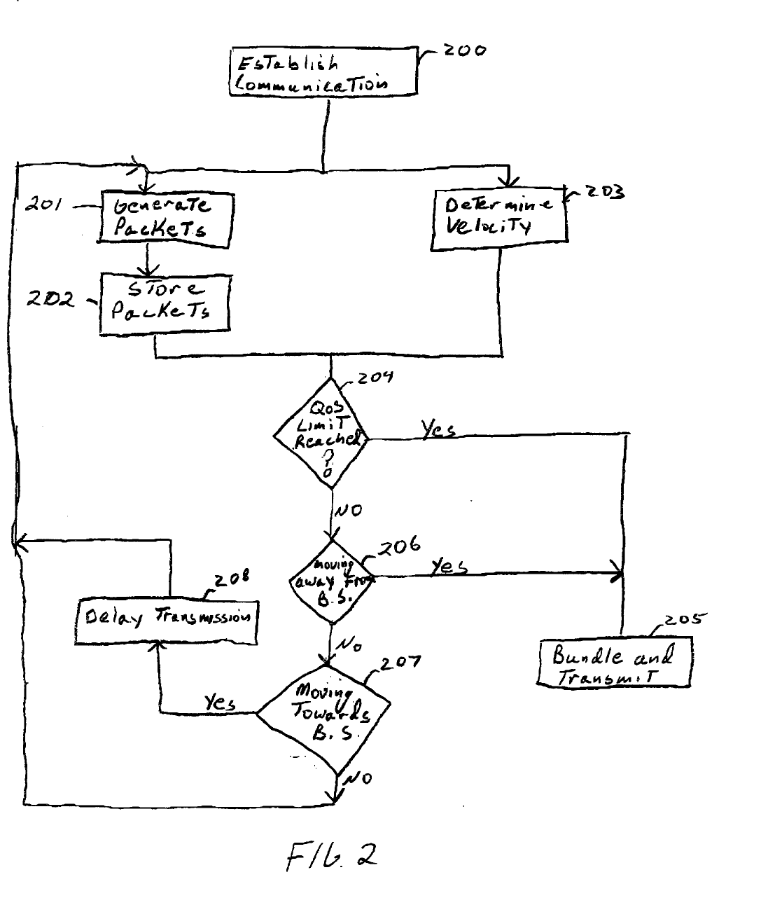

Referring now to FIG. 2, a method in accordance with an embodiment of the present invention is provided. To begin, a portable communication device (e.g., device 50 of FIG. 1) establishes a communication with a wireless network, block 200. For example, a communication device may establish communication with a base station and make a request for a particular type of service (e.g., voice, data, voice and data, etc), although the scope of the present invention is not limited in this respect. The communication device may also request a service that has particular characteristics, such as transmission bandwidth (e.g., number of bits/packet or bits/second), delay time between transmissions, maximum or minimum transmission power, etc. For example, the communication device may request a connection be established that has a bandwidth ranging from about 100 kilobits/second to 2 mega bits/second and a maximum delay ranging from about 1 millisecond to 100 millisecond, although the scope of the present invention is not limited in this respect. Additionally, the request for service may involve other parameters related to the communication. In this particular embodiment these parameters are generally referred to as quality of service parameters.

Once a communication has been established, this particular embodiment of the present invention may be able to reduce the transmission power of the communication device by either bundling packets together into one transmission. Additionally or alternatively, some embodiments of the present invention may be able to reduce the transmission power by keeping track of whether the portable communication device is approaching or moving away from the base station with which it is in communication.

While in operation, the portable communication device may generate packets of data or information that are to be transmitted to the network, block 201. For example, applications or programs running on the portable communication device may generate packets of data in response to user input (e.g., requests for data from a file or website), although the scope of the present invention is not limited in this respect. Given the interaction of a user and the nature of the applications running on the portable communication device, these packets are typically created at an irregular, non-periodic rate, although the scope of the present invention is not limited in this respect. In addition, the portable communication device may create packets of data corresponding to voice data generated by a user. However, it should be understood that the scope of the present invention is not limited by the type or origin of the packets of information to be transmitted by the portable communication device.

In accordance with this embodiment, the portable communication device may store the packets of data in memory (e.g., memory 52 of FIG. 1), block 202. As explained in more detail below, embodiments of the present invention may be able to reduce the transmission power level of the communication device by combing or bundling packets together so that they may be transmitted as part of a wireless transmission packet.

While packets of user data are being generated and stored, the portable communication device may also determine the velocity of the portable communication device with respect to the base station or stations with which it is in communication, block 203. As indicated in FIG. 2, this information may be determined or calculated in parallel with generating and storing packets of data. However, the scope of the present invention is not limited in this respect. In alternative embodiments, this may be done prior to or after the user data has been stored.

By determining the velocity of the communication device with respect to the base station, the portable communication device may be able to reduce the transmission power level. The transmission power level of a mobile communication device is generally proportional to the distance between the base station and the mobile device, although other factors such as noise, multipaths, obstructions, etc. are also considerations. However, generally, as the mobile communication device approaches the base station, it may be able to transmit to the base station at a lower power level. By reducing the transmission power of the communication device the battery life of the mobile communication device may be lengthened and the capacity of the wireless network may be increased.

Alternatively and optionally, the portable communication device may calculate or determine the effective attenuation distance between the portable communication device and the corresponding base station(s). More particularly, even if the portable communication device remains stationary with respect to the base station(s), other environmental factors such as noise, multipaths, obstructions, etc., may have changed that permit the portable communication device to transmit with a lower transmission power level. For example, an obstacle, such as a bus, between the portable communication device and the base station may have moved so that the interference between the communication device and the base station is reduced. If the effective attenuation distance between the base station and the portable communication device has been reduced, again for a variety of reasons, the portable communication device may be able to transmit at a lower power level.

In accordance with various embodiments of the present invention, the velocity of the portable communication device with respect to the base station or the effective attenuation distance between the portable communication device and the base station may be determined in a variety of ways. For example, a global position system (GPS) may be used to track the change in the location of the portable communication device with respect to the base station. Alternatively, the timing advance of signals from the portable communication device and the base station may be tracked. In yet other embodiments, the portable communication device may monitor successive power levels or power control signals being transmitted across the wireless network. It should be understood that this list is not meant to be exhaustive and that the scope of the present invention is not limited in this respect.

If the portable communication device is approaching the end of transmission time slot or time interval (e.g., the QOS calls for a transmission every 20 milliseconds and the device is approaching 20 milliseconds since the last transmission), then the portable device may transmit the packets it has collected and stored up to that point, block 204. If the portable communication device is at the end or near the end of its time slot, it may bundle the one or more packets it has stored together so that they may be transmitted as part of a wireless transmission packet, block 205. In addition to simply combining or bundling the user packets of data together to form a wireless transmission packet, the portable communication device may also optionally encrypt, compress, encode, and/or interleave the user data as part of the wireless transmission packet. Thus, the wireless transmission packet may be larger than, smaller, or equal to the sum of the user packets of data.

By waiting until the near the end of the transmission window to transmit the wireless transmission packet, the portable communication may be able to reduce its power consumption and extend the life of its battery. More particularly, by collecting smaller user packets of information and then transmitting them together, the portable communication device may be able to reduce the power associated with raising and lowering the transmission power level that would otherwise be associated with the transmission of the user packets individually. In addition, by delaying the transmission until the end, or near the end, of the transmission window, the portable communication device may be able to reduce the transmission power level if is has moved closer to the base station or if the effective attenuation distance between the base station and the mobile communication device has been reduced.

If the portable communication device has not reached the end of the transmission widow as determined by the QOS parameters, the device may continue to collect and store packets of user data for future transmission. Alternatively, if the portable communication device may determine if it is moving away from the corresponding base station(s) or if the effective attenuation distance is increasing, block 206. For example, if the portable communication device is moving away from the base station, it may have to increase its transmission power level for the next transmission since the power level is generally proportional with the distance to the base station. Accordingly, the portable communication device may bundle and transmit the packets that have been collected and stored to date so that the wireless transmission packet may be transmitted now at a lower transmission power level than if the portable communication device were to wait until the end of the transmission window.

Alternatively, the portable communication device may determine if the portable communication device is approaching the base station with which it is in communication, block 207. If the communication device is moving towards the base station, it may delay the transmission of the wireless transmission packet, block 208, so that the portable communication device may lower is transmission power level and transmit at a lower power level later in time. If there is no need or advantage to transmitting the wireless transmission packet, the portable communication device may continue to collect and store user packet data, block 201. In yet another embodiment of the present invention, the portable communication device may delay the transmission of the wireless transmission packet and reduce the transmission power level if the effective attenuation distance has been reduced. By being able to reduce the transmission power level in certain situations, particular embodiments may be able to reduce the amount of power that is consumed by a portable communication device while it is in operation. This, in turn, may extend the battery life and increase the capacity of a wireless network.

While certain features of the invention have been illustrated and described herein, many modifications, substitutions, changes, and equivalents will now occur to those skilled in the art. For example, in yet other embodiments of the present invention, only one packet of user data may be transmitted. More particularly, an embodiment may not combine or bundle individual user packets of data together into a wireless transmission. Instead, the portable communication device may store one user packet and delay the transmission of the packet if the portable communication device is moving towards the base station or if the effective attenuation distance is being reduced. It is, therefore, to be understood that the appended claims are intended to cover all such modifications and changes as fall within the true spirit of the invention.

1. A method of transmitting information through a wireless communication, comprising:
bundling at least two separate packets of user data for transmission.

2. The method of claim 1, further comprising storing at least two separate packets of user data.

3. The method of claim 2, further comprising combining the at least two separate packets of user data into a transmission packet.

4. The method of claim 3, further comprising transmitting the transmission packet with quality of service time parameters.

5. The method of claim 1, further comprising estimating the velocity of the portable communication device relative to a base station.

6. The method of claim 5, further comprising reducing transmission power of the portable communication device if the portable communication device is approaching the base station.

7. The method of claim 5, wherein estimating the velocity includes processing data from a global positioning system.

8. The method of claim 5, wherein estimating the velocity includes determining the timing advance of a transmission from the portable communication device to the base station.

9. The method of claim 5, further comprising increasing the transmission power of the portable communication device if the portable communication device is moving away from the base station.

10. The method of claim 9, further comprising:
combining the at least two separate packets of user data into a transmission packet; and
transmitting the transmission packet prior to a time interval determined by the quality of service parameters.

11. The method of claim 1, further comprising reducing transmission power of the portable communication device if the attenuation distance between the portable communication device and the base station is reduced.

12. An article comprising: a storage medium having stored thereon instructions, that, when executed by a computing platform, results in:
storing at least two packets of data;
combining the at least two packets into a wireless transmission packet; and
transmitting the wireless transmission packet.

13. The article of claim 12, wherein the instructions, when executed, further result in:
transmitting the wireless transmission packet at the end of the quality of service time interval.

14. The article of claim 12, wherein the instructions, when executed, further result in:
transmitting the wireless transmission packet prior to the end of the quality of service time interval.

15. The article of claim 12, wherein the instructions, when executed, further result in:
estimating the attenuation distance between a portable communication device and a base station.

16. The article of claim 12, wherein the instructions, when executed, further result in:
reducing the transmission power of the portable communication device if the attenuation distance has been reduced.

17. A portable communication device comprising:
a storage device adapted to store at least two packets of data; and
a transmitter adapted to transmit a transmission packet comprising the at least two packets of data.

18. The portable communication device of claim 17, wherein the portable communication device is further adapted to combine the at least two packets of data to provide at least a portion of the transmission packet.

19. The portable communication device of claim 17, further comprising a processor, wherein the processor is adapted to determine the velocity of the portable communication device relative to a base station.

20. The portable communication device of claim 19, wherein the portable communication device is further adapted to reduce the transmission power of the portable communication device if the distance between the portable communication device and the base station is reduced.

21. A method of communication with a portable communication device, comprising:
storing a packet of user data; and
delaying transmission of the packet of user data if the effective attenuation distance between the portable communication device and a base station has been reduced.

22. The method of claim 21, wherein the portable communication device is moving towards the base station.

23. The method of claim 21, further comprising storing at least two separate packets of user data.

24. The method of claim 23, further comprising combining the at least two separate packets of user data into a transmission packet.
